(19) United States
(12) Patent Application Publication
(10) Pub. No.: US 2022/0320936 A1
(43) Pub. Date: Oct. 6, 2022

(54) STATOR AND MOTOR INCLUDING THE SAME

(71) Applicant: NIDEC CORPORATION, Kyoto (JP)

(72) Inventors: Hibiki TAKADA, Kyoto (JP); Takahiro HIWA, Kyoto (JP); Hisashi FUJIHARA, Kyoto (JP); Tatsuhiko MIZUTANI, Kyoto (JP)

(21) Appl. No.: 17/616,187

(22) PCT Filed: Jun. 1, 2020
(86) PCT No.: PCT/JP2020/021518

§ 371 Date: Dec. 3, 2021

(30) Foreign Application Priority Data
Jun. 6, 2019 (JP) 2019-106504

(51) Int. Cl. H02K 3/28; H02K 1/16; H02K 3/12

(52) U.S. Cl. CPC H02K 3/28; H02K 1/16; H02K 3/12

(57) ABSTRACT

A stator includes three-phase coils in which slot accommodation portions are accommodated inside slots; three external terminals; and three busbars that electrically connect the external terminals and the coils. A first coil end and a second coil end that are positioned respectively at the ends of each of the coils extend from the radially outermost side of the slots toward the first side or the second side in the axial direction of the stator core. The winding-start coil ends of the three-phase coils are connected to busbar connection portions of different busbars.

### CROSS-REFERENCE TO RELATED APPLICATIONS

This is the U.S. national stage of application No. PCT/JP2020/021518, filed on Jun. 1, 2020, and priority under 35 U.S.C. § 119(a) and 35 U.S.C. § 365(b) is claimed from Japanese Patent Application No. 2019-106504, filed on Jun. 6, 2019.

### FIELD OF THE INVENTION

The present invention relates to a stator and a motor including the stator. The present invention claims priority based on Japanese Patent Application No. 2019-106504 filed in Japan on Jun. 6, 2019, the contents of which are incorporated herein by reference.

### BACKGROUND

As a stator having a coil formed from a rectangular wire, a stator using a connecting wire for connecting two coil ends of the same phase or different phases is known. A stator is conventionally known in which one end and the other end of a coil portion are located at an inner end and an outer end of the stator in a radial direction, respectively, and the coil ends are connected by a connecting wire.

In the conventional stator, one end and the other end (coil ends) of the coil portion extend to a first side in the axial direction of the stator. One end and the other end of the coil portion are connected by the connecting wire located on the first side in the axial direction with respect to a coil end portion located on the first side. That is, in the conventional stator described above, the connecting wire is located on the first side in the axial direction with respect to the coil end portion, which entails a problem that the stator cannot be made compact in the axial direction.

### SUMMARY

An exemplary stator according to the present invention includes: a stator core having a plurality of slots extending in an axial direction; multi-phase coils partially accommodated in the plurality of slots; a plurality of external terminals electrically connected to a power supply source; and a plurality of busbars electrically connecting the plurality of external terminals and the multi-phase coils, respectively. Each of the coils includes: a plurality of slot accommodation portions located in the plurality of slots; a plurality of coil connection portions located on a first side and on a second side in the axial direction with respect to the stator core and connecting the slot accommodation portions; a first coil end located at an end of the coil, extending from the slot accommodation portion, and protruding to the first side or the second side in the axial direction of the stator core; and a second coil end located at an end of the coil, extending from the slot accommodation portion, and protruding to the first side or the second side in the axial direction of the stator core. Each of the busbars includes: a busbar body portion positioned to overlap at least one of the first coil end and the second coil end when viewed in a radial direction of the stator core, the busbar body portion extending in a circumferential direction of the stator core; a busbar connection portion extending from the busbar body portion toward the first side in the axial direction; and an external terminal connection portion extending outward in the radial direction from the busbar body portion and connected to the external terminal. The first coil end and the second coil end of each of the multi-phase coils extend from a radially outermost side of the slots toward the first side or the second side in the axial direction, and either the first coil ends or the second coil ends of the multi-phase coils are connected to the busbar connection portions of different busbars among the plurality of busbars.

An exemplary motor according to the present invention includes the stator described above.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram illustrating a schematic configuration of a motor according to a first embodiment;

FIG. 2 is a perspective view of a stator;

FIG. 3 is a perspective view of the stator from which a busbar holder and an external terminal holder are removed;

FIG. 4 is a perspective view schematically illustrating a positional relationship between a stator core and coils;

FIG. 5A is a perspective view illustrating a schematic configuration of a U-phase busbar;

FIG. 5B is a perspective view illustrating a schematic configuration of a V-phase busbar;

FIG. 5C is a perspective view illustrating a schematic configuration of a W-phase busbar;

FIG. 5D is a perspective view illustrating a schematic configuration of a neutral point busbar;

FIG. 6 is a perspective view illustrating an arrangement of four busbars attached to a coil end portion;

FIG. 7 is a partially enlarged view illustrating connection portions between ends of the coils and the busbars;

FIG. 8 is a diagram, corresponding to FIG. 2, illustrating a stator according to a second embodiment;

FIG. 9 is a diagram, corresponding to FIG. 3, illustrating the stator according to the second embodiment;

FIG. 10 is a diagram, corresponding to FIG. 6, illustrating busbars according to the second embodiment; and

FIG. 11 is a partially enlarged view illustrating a connection portion of a busbar.

### DETAILED DESCRIPTION

Embodiments of the present invention will be described below in detail with reference to the drawings. The same or corresponding parts in the drawings are denoted by the same reference numerals, and the description thereof will not be repeated. The constituent members in the drawings are not limited to have the dimensions and the dimensional ratios illustrated in the drawings.

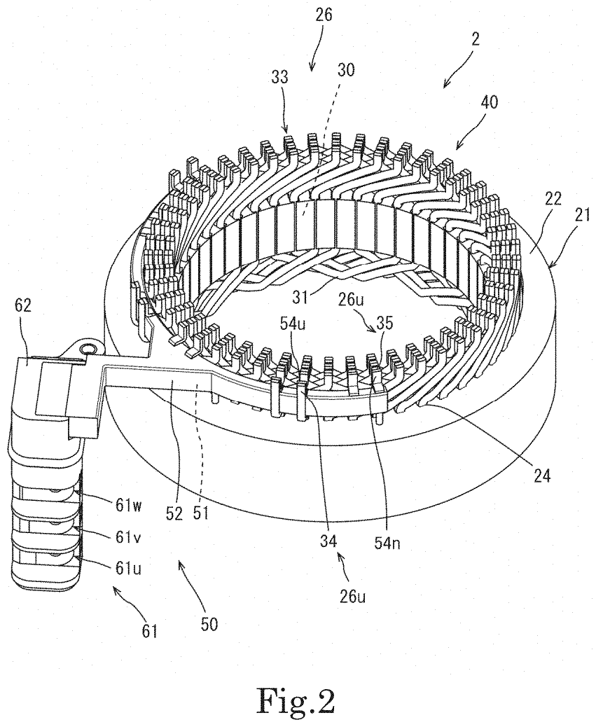

In the following description, a direction parallel to a central axis of a stator is referred to as an “axial direction”, a direction perpendicular to the central axis is referred to by the term “radial direction” or “radially”, and a direction along an arc around the central axis is referred to as a “circumferential direction”. In addition, regarding the axial direction, a side where a busbar is located with respect to the stator is referred to as a “first side”, and a side opposite to the side where the busbar is located with respect to the stator is referred to as a “second side”. That is, in the present specification, an upper side is the “first side”, and a lower side is the “second side” in FIG. 2. However, there is no intention to limit the direction at the time of using a motor according to the present invention by the definitions of the directions.

Further, in the following description, expressions such as “fixed”, “connected”, and “attached” (hereinafter, fixed, etc.) are used not only when the members are directly fixed to each other, but also when the members are fixed via another member. That is, in the following description, the expression such as “fixed” includes the meaning indicating that the members are directly fixed and the members are indirectly fixed.

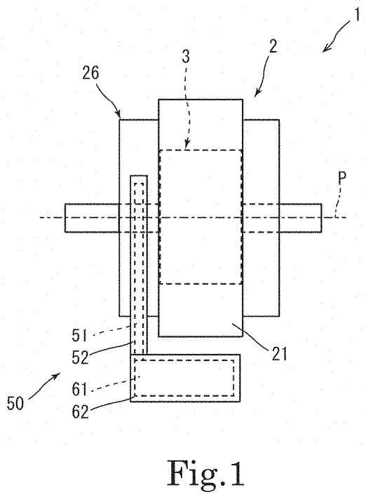

FIG. 1 shows a schematic configuration of a motor 1 according to the first embodiment of the present invention. The motor 1 includes a stator 2 and a rotor 3. The rotor 3 rotates about a central axis P with respect to the stator 2. That is, the motor 1 has the stator 2 and the rotor 3 that is rotatable with respect to the stator 2.

In the present embodiment, the motor 1 is a so-called inner rotor type motor in which the rotor 3 is located so as to be rotatable about the central axis P in the tubular stator 2. The rotor 3 includes a plurality of magnets arranged in the circumferential direction around the central axis P. Since the configuration of the rotor 3 is similar to that of a typical rotor, the detailed description of the rotor 3 will be omitted.

The stator 2 includes a stator core 21, coils 26, and a busbar unit 50. In FIG. 1, the coils 26 are illustrated in a simplified manner for the sake of description. Power is supplied to the coils 26 via busbars 51 and external terminals 61 of the busbar unit 50 described later. In the present embodiment, the coils 26 include three-phase coils 26u, 26v, and 26w as described later.

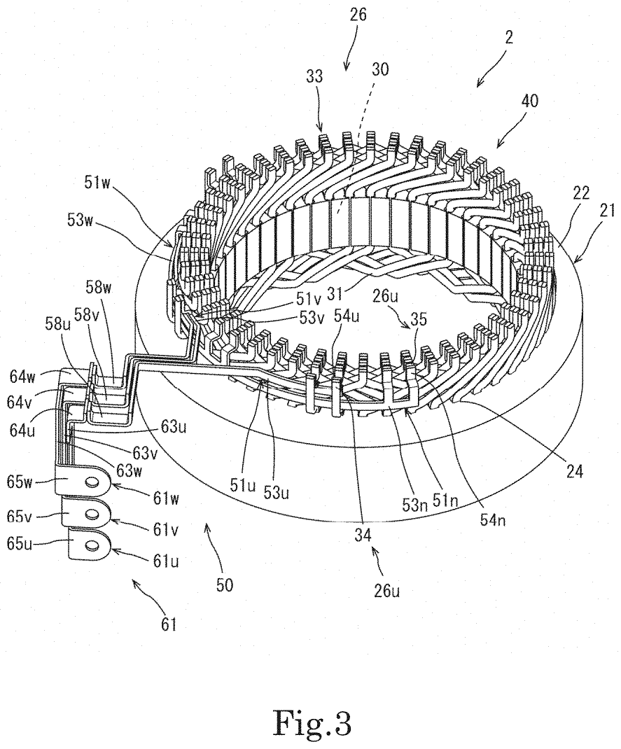

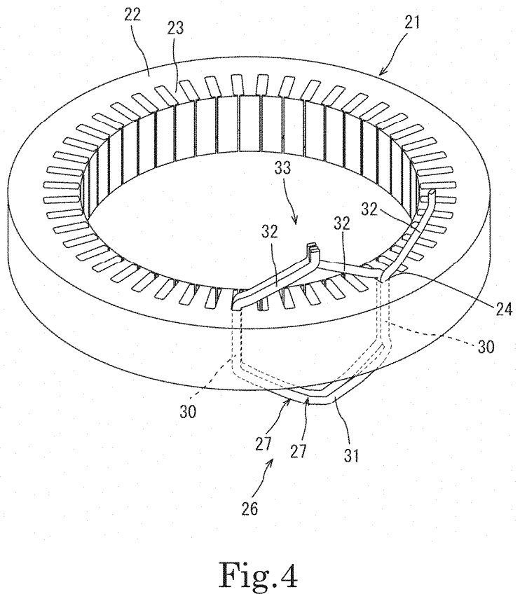

FIG. 2 is a perspective view of the stator 2 of the motor 1 according to the present embodiment. FIG. 3 is a diagram illustrating a state in which a busbar holder 52 and an external terminal holder 62 of the busbar unit 50 are removed from the stator 2 illustrated in FIG. 2. FIG. 4 is a perspective view schematically illustrating an example of a positional relationship between the stator core 21 and the coils 26. FIG. 4 only illustrates a part of the coils 26 located in slots 24 of the stator core 21 for the sake of description.

The stator core 21 has a cylindrical shape extending in the axial direction. The stator core 21 is obtained by stacking a plurality of electromagnetic steel sheets formed in a predetermined shape in the thickness direction.

The stator core 21 includes a cylindrical yoke 22, a plurality of teeth 23 (see FIG. 4) extending inward from the yoke 22 in the radial direction, and the slots 24. In the present embodiment, the stator core 21 is a cylindrical round core. The yoke 22 and the plurality of teeth 23 are integrally formed as a single member. The stator core 21 may be, for example, a split core or a straight core.

As illustrated in FIG. 4, the plurality of teeth 23 is arranged at equal intervals in the circumferential direction. Each of the teeth 23 extends from one end to the other end of the stator core 21 in the axial direction. The slot 24 is located between adjacent teeth 23 among the plurality of teeth 23. The slot 24 is a groove extending in the axial direction in the stator core 21. The slot 24 extends along the central axis P. The stator core 21 has a plurality of slots 24 arranged in the circumferential direction on the inner peripheral surface. As will be described later, a plurality of coils 26 is inserted into the plurality of slots 24.

In the present embodiment, the coils 26 include a U-phase coil 26u, a V-phase coil 26v, and a W-phase coil 26w. The coils 26 are wound around the plurality of teeth 23 in a distributed winding, and are Y-connected by the four busbars 51. In the present embodiment, the coils 26 include two sets of U-phase coils 26u, V-phase coils 26v, and W-phase coils 26w. In the following description and drawings, when it is necessary to distinguish the phases of the respective components, u, v, w, and n indicating the U phase, the V phase, the W phase, and the neutral point are added to the end of the reference numerals of the respective components.

In each of the U-phase coil 26u, the V-phase coil 26v, and the W-phase coil 26w, multiple segment coils 27 are connected in series. Each segment coil 27 has a rectangular cross-sectional shape and is constituted by a bent rectangular wire. Note that the cross-sectional shape of the segment coil 27 may not be rectangular as long as it is made of a material having high rigidity.

As illustrated in FIGS. 2 to 4, each segment coil 27 includes a pair of linear slot accommodation portions 30 located in the slots 24, a segment coil connection portion 31 connecting the pair of slot accommodation portions 30, and a pair of segment coil end portions 32 which are ends of the segment coil 27. The plurality of segment coils may include a segment coil having a linear slot accommodation portion and segment coil end portions located at both ends of the slot accommodation portion.

The slot accommodation portions 30 of the plurality of segment coils 27 are accommodated in the slots 24 while being overlapped in the radial direction. The segment coil connection portions 31 of the plurality of segment coils 27 are positioned on the second side in the axial direction with respect to the stator core 21 in a state where the slot accommodation portions 30 are accommodated in the slots 24 of the stator core 21. The slot accommodation portion 30 constitutes slot accommodation portion of the coil 26. The segment coil connection portion 31 constitutes a first coil connection portion of the coil 26. In the following description, the slot accommodation portion of the coil 26 is denoted by the same reference numeral as the slot accommodation portion 30 of the segment coil 27, and the first coil connection portion of the coil 26 is also denoted by the same reference numeral as the segment coil connection portion 31 of the segment coil 27.

In the plurality of segment coils 27, the tip of one of the pair of segment coil end portions 32 in each segment coil 27 and the tip of one of the pair of segment coil end portions 32 in the other segment coil 27 are connected by welding or the like in a state where the slot accommodation portions 30 are accommodated in the slots 24. That is, the pair of segment coil end portions 32 in each segment coil 27 is connected to the segment coil end portions 32 of the different segment coil 27. Thus, the plurality of segment coils 27 is connected in series. The U-phase coil 26u, the V-phase coil 26v, and the W-phase coil 26w are each constituted by the plurality of segment coils 27 connected in series in this manner.

In the present embodiment, the connected segment coil end portions 32 constitute a second coil connection portion 33 that connects the pair of slot accommodation portions 30 in each of the U-phase coil 26u, the V-phase coil 26v, and the W-phase coil 26w. The second coil connection portion 33 is located on the first side in the axial direction with respect to the stator core 21.

Each of the U-phase coil 26u, the V-phase coil 26v, and the W-phase coil 26w has a pair of segment coil end portions 32 that is not connected to the segment coil end portions 32 of the other segment coil 27. The segment coil end portions 32 that are not connected to the other segment coil end portions 32 in the U-phase coil 26u, the V-phase coil 26v, and the W-phase coil 26w are coil ends of the U-phase coil 26u, the V-phase coil 26v, and the W-phase coil 26w. The coil ends of the U-phase coil 26u, the V-phase coil 26v, and the W-phase coil 26w are located at one end and the other end of the coil of each phase. The coil ends of the U-phase coil 26u, the V-phase coil 26v, and the W-phase coil 26w protrude to the first side in the axial direction of the stator core 21. One end and the other end of the coil of each phase correspond to a first coil end and a second coil end, respectively.

Hereinafter, for the sake of description, the coil ends located at both ends of each of the U-phase coil 26u, the V-phase coil 26v, and the W-phase coil 26w are referred to as a winding-start coil end 34 and a winding-end coil end 35, respectively. However, this is not intended to specify the winding order of the coil or the direction in which a current flows.

That is, the coils 26 of the present embodiment include the U-phase coil 26u, the V-phase coil 26v, and the W-phase coil 26w, and the coils 26 include the plurality of slot accommodation portions 30 positioned in the plurality of slots, the plurality of second coil connection portions 33 positioned on the first side in the axial direction with respect to the stator core 21 and connecting the slot accommodation portions 30, the plurality of first coil connection portions 31 positioned on the second side in the axial direction with respect to the stator core 21 and connecting the slot accommodation portions 30, and the winding-start coil ends 34 and the winding-end coil ends 35 positioned at the ends of the coils 26, extending from the slot accommodation portions 30, and protruding to the first side in the axial direction of the stator core 21. The first coil connection portion 31 and the second coil connection portion 33 correspond to the coil connection portion.

With this configuration, the coil end portion 40 that includes the plurality of second coil connection portions 33 protruding from the stator core 21 to the first side in the axial direction is formed on the first side in the axial direction with respect to the stator core 21. A coil end portion that includes the plurality of first coil connection portions 31 protruding from the stator core 21 to the second side is formed on the second side in the axial direction with respect to the stator core 21.

In the present embodiment, all the second coil connection portions 33 are positioned on the first side in the axial direction (upper side in FIG. 2) with respect to the stator core 21, and all the first coil connection portions 31 are positioned on the second side in the axial direction (lower side in FIG. 2) with respect to the stator core 21. In addition, all the winding-start coil ends 34 and all the winding-end coil ends 35 are located on the first side in the axial direction where the second coil connection portions 33 are located.

The winding-start coil end 34 and the winding-end coil end 35 of each of the U-phase coil 26u, the V-phase coil 26v, and the W-phase coil 26w extend from the slot accommodation portions 30 located on the radially outermost side of the slots 24 and protrude from the stator core 21. The winding-start coil end 34 and the winding-end coil end 35 are the segment coil end portions 32 of the segment coil 27 located on the radially outermost side of the slot 24 in the U-phase coil 26u, the V-phase coil 26v, and the W-phase coil 26w. In the present embodiment, the coils 26 include two sets of U-phase coils 26u, V-phase coils 26v, and W-phase coils 26w. Therefore, six winding-start coil ends 34 and six winding-end coil ends 35 are located on the first side in the axial direction with respect to the stator core 21.

In the winding-start coil end 34 of each of the U-phase coil 26u, the V-phase coil 26v, and the W-phase coil 26w, a portion protruding from the stator core 21 extends outward in the radial direction of the stator core 21, and has a tip extending toward the first side in the axial direction of the stator core 21. The tip of each winding-start coil end 34 is located on the outermost peripheral side of the coil end portion 40 in the radial direction.

As illustrated in FIG. 2, the busbar unit 50 includes the busbars 51, the busbar holder 52, the external terminals 61, and the external terminal holder 62.

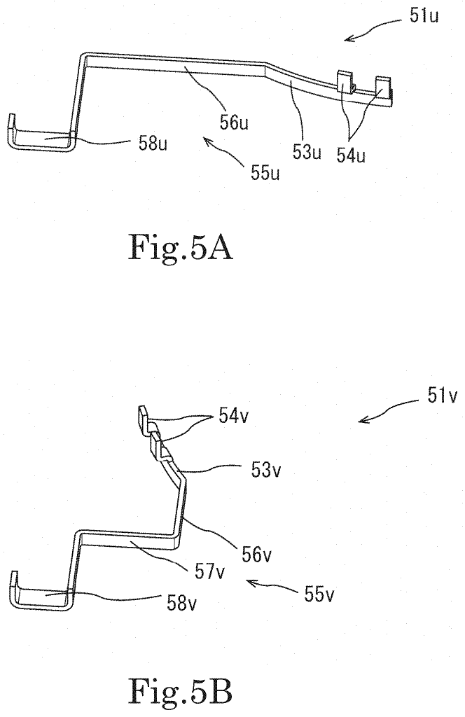

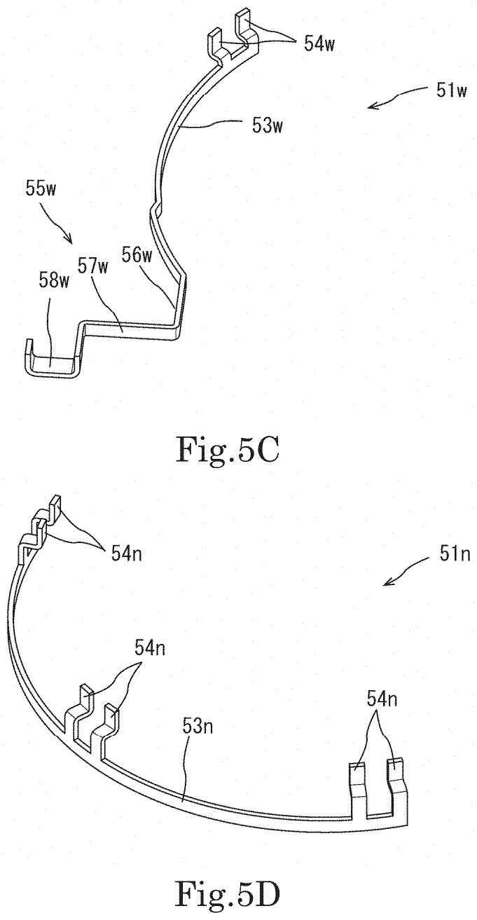

As illustrated in FIG. 3, the busbars 51 include a U-phase busbar 51u, a V-phase busbar 51v, a W-phase busbar 51w, and a neutral point busbar 51n. FIG. 5A illustrates a schematic configuration of the U-phase busbar 51u, FIG. 5B illustrates a schematic configuration of the V-phase busbar 51v, FIG. 5C illustrates a schematic configuration of the W-phase busbar 51w, and FIG. 5D illustrates a schematic configuration of the neutral point busbar 51n. Each of the U-phase busbar 51u, the V-phase busbar 51v, the W-phase busbar 51w, and the neutral point busbar 51n is a plate-shaped member. The thickness direction of each of the U-phase busbar 51u, the V-phase busbar 51v, the W-phase busbar 51w, and the neutral point busbar 51n coincides with the radial direction of the stator core 21.

As illustrated in FIG. 5A, the U-phase busbar 51u includes a U-phase busbar body portion 53u, two U-phase busbar connection portions 54u, and a U-phase external terminal connection portion 55u. The U-phase busbar body portion 53u, the two U-phase busbar connection portions 54u, and the U-phase external terminal connection portion 55u are integrally formed as a single member.

As illustrated in FIG. 5B, the V-phase busbar 51v includes a V-phase busbar body portion 53v, two V-phase busbar connection portions 54v, and a V-phase external terminal connection portion 55v. The V-phase busbar body portion 53v, the two V-phase busbar connection portions 54v, and the V-phase external terminal connection portion 55v are integrally formed as a single member.

As illustrated in FIG. 5C, the W-phase busbar 51w includes a W-phase busbar body portion 53w, two W-phase busbar connection portions 54w, and a W-phase external terminal connection portion 55w. The W-phase busbar body portion 53w, the two W-phase busbar connection portions 54w, and the W-phase external terminal connection portion 55w are integrally formed as a single member.

As illustrated in FIG. 5D, the neutral point busbar 51n includes a neutral point busbar body portion 53n and six neutral point busbar connection portions 54n. The neutral point busbar body portion 53n and the six neutral point busbar connection portions 54n are integrally formed as a single member.

Each of the U-phase busbar body portion 53u, the V-phase busbar body portion 53v, and the W-phase busbar body portion 53w has an arc shape along the outer periphery of the coil end portion 40 when viewed in the axial direction. Each of the U-phase busbar body portion 53u, the V-phase busbar body portion 53v, and the W-phase busbar body portion 53w is positioned to overlap the winding-start coil end 34 of the coil 26 of each phase when viewed in the radial direction of the stator core 21, and extends in the circumferential direction of the stator core 21.

Specifically, the U-phase busbar body portion 53u is positioned to overlap the winding-start coil ends 34 of the two U-phase coils 26u when viewed in the radial direction of the stator core 21, and extends in the circumferential direction of the stator core 21. The V-phase busbar body portion 53v is positioned to overlap the winding-start coil ends 34 of the two V-phase coils 26v when viewed in the radial direction of the stator core 21, and extends in the circumferential direction of the stator core 21. The W-phase busbar body portion 53w of the W-phase busbar 51w is positioned to overlap the winding-start coil ends 34 of the two W-phase coils 26w when viewed in the radial direction of the stator core 21, and extends in the circumferential direction of the stator core 21.

The neutral point busbar body portion 53n of the neutral point busbar 51n has an arc shape along the outer periphery of the coil end portion 40 when viewed in the axial direction. The neutral point busbar body portion 53n is positioned to overlap the winding-end coil ends 35 of the two U-phase coils 26u, two V-phase coils 26v, and two W-phase coils 26w when viewed in the radial direction of the stator core 21, and extends in the circumferential direction of the stator core 21. In the present embodiment, the neutral point busbar body portion 53n is longer in the circumferential direction than the U-phase busbar body portion 53u, the V-phase busbar body portion 53v, and the W-phase busbar body portion 53w.

The U-phase external terminal connection portion 55u extends outward from one end of the U-phase busbar body portion 53u in the radial direction and is connected to the external terminal 61. The U-phase external terminal connection portion 55u includes a U-phase extension portion 56u extending outward of the stator core 21 in the radial direction from one end of the U-phase busbar body portion 53u, and a U-phase connection end portion 58u located at the tip of the U-phase extension portion 56u and connected to the external terminal 61.

The V-phase external terminal connection portion 55v extends outward from one end of the V-phase busbar body portion 53v in the radial direction and is connected to the external terminal 61. The V-phase external terminal connection portion 55v includes: a V-phase first extension portion 56v extending outward of the stator core 21 in the radial direction from one end of the V-phase busbar body portion 53v; a V-phase second extension portion 57v that is perpendicular to the V-phase first extension portion 56v and that extends toward the external terminal 61; and a V-phase connection end portion 58v located at the tip of the V-phase second extension portion 57v and connected to the external terminal 61.

The W-phase external terminal connection portion 55w extends outward from one end of the W-phase busbar body portion 53w in the radial direction and is connected to the external terminal 61. The W-phase external terminal connection portion 55w includes: a W-phase first extension portion 56w extending outward of the stator core 21 in the radial direction from one end of the W-phase busbar body portion 53w; a W-phase second extension portion 57w that is perpendicular to the W-phase first extension portion 56w and that extends toward the external terminal 61; and a W-phase connection end portion 58w located at the tip of the W-phase second extension portion 57w and connected to the external terminal 61.

The detailed configuration of the external terminal 61 will be described later.

The two U-phase busbar connection portions 54u are connected to the winding-start coil ends 34 of the U-phase coils 26u. The two V-phase busbar connection portions 54v are connected to the winding-start coil ends 34 of the V-phase coils 26v. The two W-phase busbar connection portions 54w are connected to the winding-start coil ends 34 of the W-phase coils 26w. The neutral point busbar connection portions 54n are connected to the winding-end coil ends 35 of the two sets of coils of respective phases.

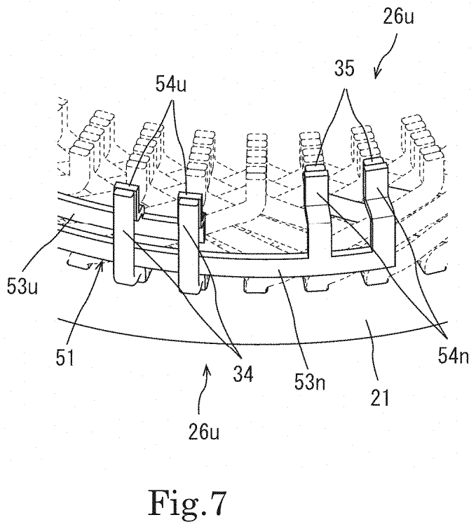

FIG. 7 is an enlarged view illustrating, as an example, connection portions between the winding-start coil ends 34 of the U-phase coils 26u and the two U-phase busbar connection portions 54u and connection portions between the winding-end coil ends 35 of the U-phase coils 26u and the neutral point busbar connection portions 54n. Note that FIG. 7 does not illustrate the busbar holder 52 to be described later for the sake of description.

As illustrated in FIG. 7, the two U-phase busbar connection portions 54u are arranged in the circumferential direction, extend to the first side in the axial direction of the stator core 21 from the other end of the U-phase busbar body portion 53u, and are connected to the winding-start coil ends 34 of the U-phase coils 26u. The six neutral point busbar connection portions 54n are arranged in pairs in the circumferential direction, extend to the first side in the axial direction of the stator core 21 from the neutral point busbar body portion 53n, and are connected to the winding-end coil ends 35 of two sets of coils of respective phases.

Although not particularly illustrated, similar to the U-phase busbar connection portions 54u, the two V-phase busbar connection portions 54v are arranged in the circumferential direction, extend to the first side in the axial direction of the stator core 21 from the V-phase busbar body portion 53v, and are connected to the winding-start coil ends 34 of the V-phase coils 26v. Similar to the U-phase busbar connection portions 54u, the two W-phase busbar connection portions 54w are arranged in the circumferential direction, extend to the first side in the axial direction of the stator core 21 from the W-phase busbar body portion 53w, and are connected to the winding-start coil ends 34 of the W-phase coils 26w.

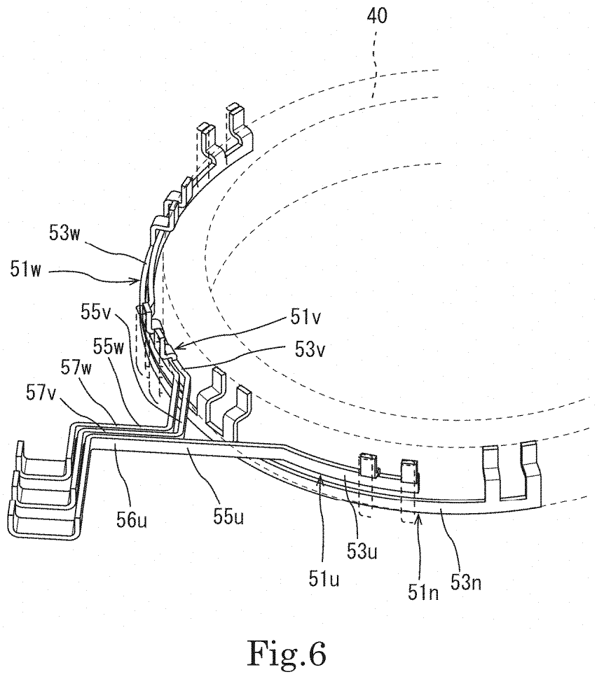

The U-phase busbar 51u, the V-phase busbar 51v, the W-phase busbar 51w, and the neutral point busbar 51n are located on the outer peripheral side of the coil end portion 40 in the radial direction in a state of partially overlapping each other in the radial direction or the axial direction. FIG. 6 illustrates an example of the arrangement of the U-phase busbar 51u, the V-phase busbar 51v, the W-phase busbar 51w, and the neutral point busbar 51n with respect to the coil end portion 40.

As shown in FIG. 6, the U-phase extension portion 56u of the U-phase external terminal connection portion 55u, the V-phase second extension portion 57v of the V-phase external terminal connection portion 55v, and the W-phase second extension portion 57w of the W-phase external terminal connection portion 55w overlap each other in the thickness direction.

The U-phase busbar body portion 53u is located on a first side in the circumferential direction of the stator core 21 with respect to the U-phase external terminal connection portion 55u when viewed in the axial direction. The W-phase busbar body portion 53w is located on a second side in the circumferential direction of the stator core 21 with respect to the W-phase external terminal connection portion 55w when viewed in the axial direction. The V-phase busbar body portion 53v is located on the second side in the circumferential direction of the stator core 21 with respect to the V-phase external terminal connection portion 55v when viewed in the axial direction, and the V-phase busbar body portion 53v overlaps a part of the W-phase busbar body portion 53w when viewed in the radial direction of the stator core 21.

The neutral point busbar body portion 53n is located on the second side in the axial direction with respect to the U-phase busbar body portion 53u, the V-phase busbar body portion 53v, and the W-phase busbar body portion 53w, and a part of the neutral point busbar body portion 53n overlaps the U-phase busbar body portion 53u, the V-phase busbar body portion 53v, and the W-phase busbar body portion 53w when viewed in the axial direction.

As described above, at least two of the four busbars are positioned to partially overlap each other when viewed in the axial direction of the stator core 21. By arranging at least two of the four busbars in the axial direction as described above, the number of busbars arranged in the radial direction can be reduced. Therefore, the stator 2 that is compact in the radial direction can be obtained.

In addition, at least two of the four busbars are positioned to partially overlap each other when viewed in the radial direction of the stator core 21. By arranging at least two of the four busbars in the radial direction as described above, the number of busbars arranged in the axial direction can be reduced. Therefore, the stator 2 that is compact in the axial direction can be obtained.

The number of busbars positioned to overlap each other in the axial direction or the radial direction among the four busbars is not limited to that described above. In addition, the four busbars may be overlapped in an arrangement other than the arrangement described above.

The U-phase busbar 51u, the V-phase busbar 51v, the W-phase busbar 51w, and the neutral point busbar 51n are molded with resin except for the tips of the U-phase busbar connection portions 54u, the V-phase busbar connection portions 54v, the W-phase busbar connection portions 54w, and the neutral point busbar connection portions 54n (see FIG. 2). In the present specification, a resin portion covering the four busbars 51 is referred to as the busbar holder 52.

That is, in a state where the U-phase busbar 51u, the V-phase busbar 51v, the W-phase busbar 51w, and the neutral point busbar 51n are covered with the busbar holder 52, the tips of the U-phase busbar connection portions 54u, the V-phase busbar connection portions 54v, the W-phase busbar connection portions 54w, and the neutral point busbar connection portions 54n protrude from the busbar holder 52.

As illustrated in FIG. 2, the U-phase busbar 51u, the V-phase busbar 51v, the W-phase busbar 51w, and the neutral point busbar 51n are located radially inside the tips of the winding-start coil ends 34 and radially outside the second coil connection portions 33 in a state of being covered with the busbar holder 52.

As described above, in the winding-start coil end 34, a portion protruding from the stator core 21 to the first side in the axial direction extends outward in the radial direction of the stator core 21, and has a tip extending toward the first side in the axial direction of the stator core 21. Therefore, the winding-start coil end 34 extends in the radial direction through between the busbar unit 50 and the stator core 21 in the axial direction, that is, over the second side in the axial direction of the busbar unit 50, and extends to the first side in the axial direction on the outside of the busbar unit 50 in the radial direction.

In this state, the tips of the winding-start coil ends 34 are connected respectively to the tips of the U-phase busbar connection portions 54u, the V-phase busbar connection portions 54v, and the W-phase busbar connection portions 54w on the radially outer side and on the first side in the axial direction with respect to the busbar unit 50. Further, the winding-end coil ends 35 are connected to the tips of the neutral point busbar connection portions 54n on the radially inner side of the busbar unit 50.

With the configuration described above, the busbar unit 50 can be fixed to the coil end portion 40 on the radially inner side and on the radially outer side.

As illustrated in FIGS. 2 and 3, the external terminals 61 include a U-phase external terminal 61u, a V-phase external terminal 61v, and a W-phase external terminal 61w. The U-phase external terminal 61u, the V-phase external terminal 61v, and the W-phase external terminal 61w are plate-shaped members and molded with resin. In the present specification, the resin portion covering the three external terminals 61 is referred to as the external terminal holder 62.

The U-phase external terminal 61u includes a U-phase terminal body portion 63u, a U-phase busbar-side connection portion 64u located at one end of the U-phase terminal body portion 63u, and a U-phase power-supply-source-side connection portion 65u located at another end of the U-phase terminal body portion 63u. The U-phase terminal body portion 63u, the U-phase busbar-side connection portion 64u, and the U-phase power-supply-source-side connection portion 65u are integrally formed as a single member.

The V-phase external terminal 61v includes a V-phase terminal body portion 63v, a V-phase busbar-side connection portion 64v located at one end of the V-phase terminal body portion 63v, and a V-phase power-supply-source-side connection portion 65v located at another end of the V-phase terminal body portion 63v. The V-phase terminal body portion 63v, the V-phase busbar-side connection portion 64v, and the V-phase power-supply-source-side connection portion 65v are integrally formed as a single member.

The W-phase external terminal 61w includes a W-phase terminal body portion 63w, a W-phase busbar-side connection portion 64w located at one end of the W-phase terminal body portion 63w, and a W-phase power-supply-source-side connection portion 65w located at another end of the W-phase terminal body portion 63w. The W-phase terminal body portion 63w, the W-phase busbar-side connection portion 64w, and the W-phase power-supply-source-side connection portion 65w are integrally formed as a single member.

The U-phase external terminal 61u, the V-phase external terminal 61v, and the W-phase external terminal 61w are molded with a resin in a state where the U-phase terminal body portion 63u, the V-phase terminal body portion 63v, and the W-phase terminal body portion 63w are overlapped in the thickness direction. Note that the external terminal holder 62 which is a resin portion covering the external terminals 61 is connected to the busbar holder 52.

The U-phase busbar-side connection portion 64u is connected to the U-phase connection end portion 58u of the U-phase busbar 51u. The V-phase busbar-side connection portion 64v is connected to the V-phase connection end portion 58v of the V-phase busbar 51v. The W-phase busbar-side connection portion 64w is connected to the W-phase connection end portion 58w of the W-phase busbar 51w.

A power supply source (not illustrated) is electrically connected to the U-phase power-supply-source-side connection portion 65u, the V-phase power-supply-source-side connection portion 65v, and the W-phase power-supply-source-side connection portion 65w. With this configuration, power is supplied to the U-phase coil 26u, the V-phase coil 26v, and the W-phase coil 26w via the U-phase busbar 51u, the V-phase busbar 51v, and the W-phase busbar 51w.

A connection method of the U-phase coils 26u, the V-phase coils 26v, and the W-phase coils 26w in the present embodiment will be described below.

In the present embodiment, the U-phase coils 26u, the V-phase coils 26v, and the W-phase coils 26w are Y-connected by the U-phase busbar 51u, the V-phase busbar 51v, the W-phase busbar 51w, and the neutral point busbar 51n.

Specifically, the winding-start coil ends 34 of the U-phase coils 26u are connected to the U-phase busbar connection portions 54u. The winding-start coil ends 34 of the V-phase coils 26v are connected to the V-phase busbar connection portions 54v of the V-phase busbar 51v. The winding-start coil ends 34 of the W-phase coils 26w are connected to the W-phase busbar connection portions 54w of the W-phase busbar 51w. Further, the six winding-end coil ends 35 of the U-phase coils 26u, the V-phase coils 26v, and the W-phase coils 26w are connected to the neutral point busbar 51n.

Thus, the stator 2 can be obtained in which the U-phase coils 26u, the V-phase coils 26v, and the W-phase coils 26w wound around the stator core 21 are Y-connected by the U-phase busbar 51u, the V-phase busbar 51v, the W-phase busbar 51w, and the neutral point busbar 51n.

In the stator of the present embodiment, it is possible to obtain a stator in which the coils are Δ-connected by changing the positions of the busbar connection portions with respect to the coils 26.

For example, the winding-end coil ends 35 of the U-phase coil 26u, the V-phase coil 26v, and the W-phase coil 26w may be connected to a busbar to which the winding-start coil ends 34 of coils of other phases are connected. For example, the winding-start coil end of the U-phase coil and the winding-end coil end of the V-phase coil may be connected to the busbar connection portions of the U-phase busbar, the winding-start coil end of the V-phase coil and the winding-end coil end of the W-phase coil may be connected to the busbar connection portions of the V-phase busbar, and the winding-start coil end of the W-phase coil and the winding-end coil end of the U-phase coil may be connected to the busbar connection portions of the W-phase busbar. With this configuration, a stator in which three-phase coils wound around the stator core are A-connected by the busbars can be obtained.

As described above, the three-phase coils can be Y-connected or Δ-connected by changing the connection structure of the busbars with respect to the three-phase coils.

As described above, the stator 2 according to the present embodiment includes: the stator core 21 having a plurality of slots extending in the axial direction; multi-phase coils 26 partially accommodated in the plurality of slots 24; a plurality of external terminals 61 electrically connected to a power supply source; and a plurality of busbars 51 electrically connecting the plurality of external terminals 61 and the multi-phase coils 26, respectively.

Each of the coils 26 includes: the plurality of slot accommodation portions 30 located in the plurality of slots 24; the plurality of coil connection portions 31 and 33 located on the first side and on the second side in the axial direction with respect to the stator core 21 and connecting the slot accommodation portions 30; the winding-start coil end 34 located at an end of the coil 26, extending from the slot accommodation portion 30, and protruding to the first side or the second side in the axial direction of the stator core 21; and the winding-end coil end 35 located at the end of the coil 26, extending from the slot accommodation portion 30, and protruding to the first side or the second side in the axial direction of the stator core 21.

Each of the busbars 51 includes: a busbar body portion 53 that is positioned to overlap at least one of the winding-start coil end 34 and the winding-end coil end 35 when viewed in the radial direction of the stator core 21 and that extends in the circumferential direction of the stator core 21; a busbar connection portion 54 extending from the busbar body portion 53 toward the first side in the axial direction; and an external terminal connection portion 55 extending outward in the radial direction from the busbar body portion 53 and connected to the external terminal 61.

The winding-start coil end 34 and the winding-end coil end 35 that are positioned respectively at the ends of each of the multi-phase coils 26 extend from the radially outermost side of the slots 24 toward the first side or the second side in the axial direction. Either the winding-start coil ends 34 or the winding-end coil ends 35 of the multi-phase coils 26 are connected to the busbar connection portions 54 of different busbars 51 among the plurality of busbars 51.

With the above configuration, since the winding-start coil ends 34 and the winding-end coil ends 35 protrude to the first side of the stator core 21 from the slot accommodation portions 30 located on the radially outermost side of the slots 24, the busbars 51 can be directly connected to the coils 26 at positions where they overlap the winding-start coil ends 34 and the winding-end coil ends 35 when viewed in the radial direction.

In a configuration in which the winding-start coil end and the winding-end coil end are located separately on the radially inner side and the radially outer side with respect to the coil end portion, a connecting wire crossing one side of the coil end portion in the radial direction is required. On the other hand, since the winding-start coil end 34 and the winding-end coil end 35 protrude to the first side of the stator core 21 from the slot accommodation portions 30 located on the radially outermost side of the slots 24 as described above, the connecting wire is unnecessary.

As described above, the busbars 51 can be positioned to overlap the winding-start coil ends 34 and the winding-end coil ends 35 when viewed in the radial direction, and the connecting wire is unnecessary, so that the stator 2 can be made compact in the axial direction.

In the present embodiment, the multi-phase coils 26 include the three-phase coils 26u, 26v, and 26w. The plurality of busbars 51 includes the three busbars 51u, 51v, and 51w. The plurality of external terminals 61 includes the three external terminals 61u, 61v, and 61w. Each of the three busbars 51u, 51v, and 51w electrically connects one of the three external terminals 61u, 61v, and 61w and the coil of one phase among the coils 26u, 26v, and 26w of three phases. As described above, the configuration of the present embodiment can be applied to the stator 2 in which the three-phase coils 26u, 26v, and 26w are wound around the stator core 21.

In addition, the stator 2 according to the present embodiment includes the neutral point busbar 51n positioned to overlap the winding-start coil ends 34 and the winding-end coil ends 35 when viewed in the radial direction of the stator core 21. The other of the winding-start coil ends 34 and the winding-end coil ends 35 of the multi-phase coils 26 are connected to the neutral point busbar 51n. With this configuration, the stator 2 in which the multi-phase coils 26 wound around the stator core 21 are Y-connected by the busbars 51 can be obtained.

The motor 1 according to the present embodiment includes the stator 2 having the above configuration. As a result, the motor 1 including the stator 2 having the above configuration can be obtained.

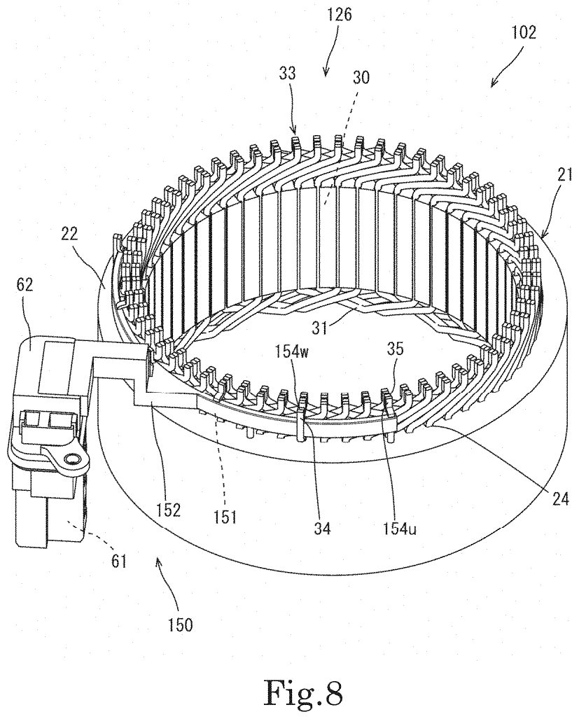

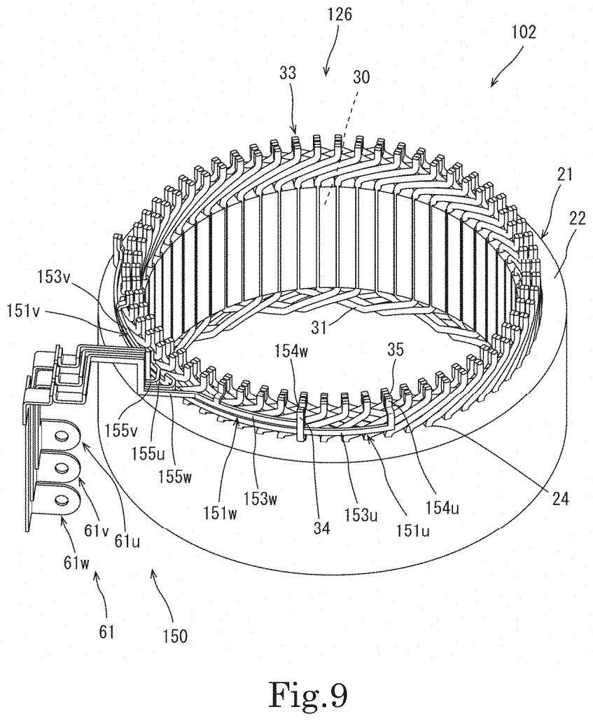

FIGS. 8 and 9 illustrate a schematic configuration of a stator 102 of a motor according to a second embodiment. The motor according to the second embodiment is different from the motor 1 according to the first embodiment in the method of connecting coils 126 by busbars 151. In the following, the same components as those in the first embodiment will be designated by the same reference numerals and the description thereof will be omitted. Only the parts different from those in the first embodiment will be described. FIG. 8 is a perspective view of the stator 102. FIG. 9 is a diagram illustrating a state in which a busbar holder 152 and an external terminal holder 62 of the busbar unit 150 are removed from the stator 102 illustrated in FIG. 8.

The stator 102 includes a stator core 21, the coils 126, and the busbar unit 150.

The coils 126 include a U-phase coil 126u, a V-phase coil 126v, and a W-phase coil 126w. The U-phase coil 126u, the V-phase coil 126v, and the W-phase coil 126w are wound around a plurality of teeth 23 of the stator core 21 in distributed winding, and are A-connected by the busbars 151 of the busbar unit 150. The winding of the U-phase coil 126u, the V-phase coil 126v, and the W-phase coil 126w with respect to the stator core 21 is similar to that in the first embodiment.

In each of the U-phase coil 126u, the V-phase coil 126v, and the W-phase coil 126w, a plurality of segment coils 27 is connected in series. The configuration of the segment coils is similar to that in the first embodiment, and thus, the description thereof will be omitted.

As in the first embodiment, the winding-start coil end 34 and the winding-end coil end 35 of each of the U-phase coil 126u, the V-phase coil 126v, and the W-phase coil 126w extend from the slot accommodation portions 30 located on the radially outermost side of the slots 24 and protrude to the first side in the axial direction of the stator core 21. In the present embodiment, the U-phase coil 126u, the V-phase coil 126v, and the W-phase coil 126w each include one winding-start coil end 34 and one winding-end coil end 35.

As illustrated in FIG. 8, the busbar unit 150 includes the busbars 151, the busbar holder 152, external terminals 61, and the external terminal holder 62.

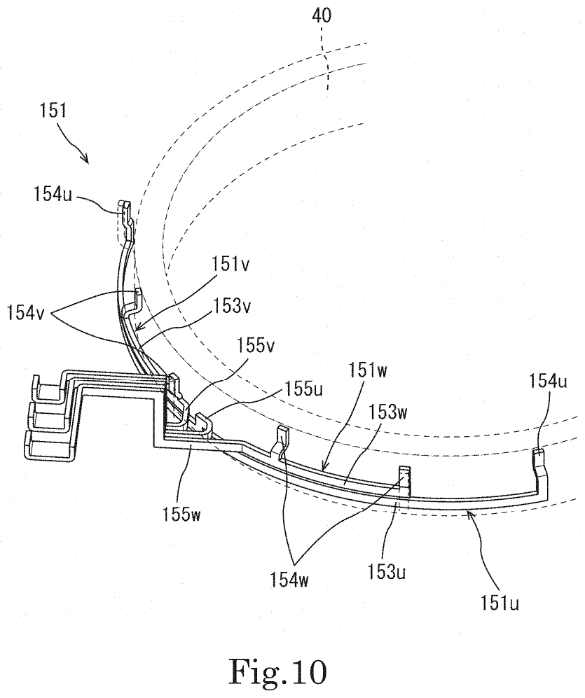

As illustrated in FIGS. 9 and 10, the busbars 151 include a U-phase busbar 151u, a V-phase busbar 151v, and a W-phase busbar 151w. Each of the U-phase busbar 151u, the V-phase busbar 151v, and the W-phase busbar 151w is a plate-like member. The thickness direction of each of the U-phase busbar 151u, the V-phase busbar 151v, and the W-phase busbar 151w coincides with the radial direction of the stator core 21.

The U-phase busbar 151u includes a U-phase busbar body portion 153u, two U-phase busbar connection portions 154u, and a U-phase external terminal connection portion 155u. The U-phase busbar body portion 153u, the two U-phase busbar connection portions 154u, and the U-phase external terminal connection portion 155u are integrally formed as a single member.

The V-phase busbar 151v includes a V-phase busbar body portion 153v, two V-phase busbar connection portions 154v, and a V-phase external terminal connection portion 155v. The V-phase busbar body portion 153v, the two V-phase busbar connection portions 154v, and the V-phase external terminal connection portion 155v are integrally formed as a single member.

The W-phase busbar 151w includes a W-phase busbar body portion 153w, two W-phase busbar connection portions 154w, and a W-phase external terminal connection portion 155w. The W-phase busbar body portion 153w, the two W-phase busbar connection portions 154w, and the W-phase external terminal connection portion 155w are integrally formed as a single member.

Each of the U-phase busbar body portion 153u, the V-phase busbar body portion 153v, and the W-phase busbar body portion 153w has an arc shape along the outer periphery of a coil end portion 40 when viewed in the axial direction. Each of the U-phase busbar body portion 153u, the V-phase busbar body portion 153v, and the W-phase busbar body portion 153w is positioned to overlap the winding-start coil end 34 of the coil 126 of each phase when viewed in the radial direction of the stator core 21, and extends in the circumferential direction of the stator core 21.

Specifically, the U-phase busbar body portion 153u is positioned to overlap the winding-start coil end 34 of the U-phase coil 126u and the winding-end coil end 35 of the W-phase coil 126w when viewed in the radial direction of the stator core 21, and extends in the circumferential direction of the stator core 21. The U-phase busbar body portion 153u is longer in the circumferential direction than the V-phase busbar body portion 153v and the W-phase busbar body portion 153w. That is, both ends of the U-phase busbar body portion 153u in the circumferential direction are located at positions distant from both ends of the V-phase busbar body portion 153v in the circumferential direction and from both ends of the W-phase busbar body portion 153w in the circumferential direction.

The V-phase busbar body portion 153v is positioned to overlap the winding-start coil end 34 of the V-phase coil 126v and the winding-end coil end 35 of the U-phase coil 126u when viewed in the radial direction of the stator core 21, and extends in the circumferential direction of the stator core 21.

The W-phase busbar body portion 153w is positioned to overlap the winding-start coil end 34 of the W-phase coil 126w and the winding-end coil end of the V-phase coil 126v when viewed in the radial direction of the stator core 21, and extends in the circumferential direction of the stator core 21.

The U-phase external terminal connection portion 155u extends outward from a position other than both ends of the U-phase busbar body portion 153u in the radial direction and is connected to the external terminal 61. The V-phase external terminal connection portion 155v extends outward from one end of the V-phase busbar body portion 153v in the radial direction and is connected to the external terminal 61. The W-phase external terminal connection portion 155w extends outward from one end of the W-phase busbar body portion 153w in the radial direction and is connected to the external terminal 61.

The configurations of the U-phase external terminal connection portion 155u, the V-phase external terminal connection portion 155v, and the W-phase external terminal connection portion 155w are similar to those in the first embodiment except that extension portions are bent in the axial direction of the stator core 21. Therefore, the detailed description of the U-phase external terminal connection portion 155u, the V-phase external terminal connection portion 155v, and the W-phase external terminal connection portion 155w will be omitted.

The connection structure between the U-phase external terminal connection portion 155u and the U-phase busbar body portion 153u will be described later.

The two U-phase busbar connection portions 154u extend to the first side in the axial direction of the stator core 21 from both ends of the U-phase busbar body portion 153u, and are connected to the winding-start coil end 34 of the U-phase coil 126u and the winding-end coil end 35 of the W-phase coil 126w.

The two V-phase busbar connection portions 154v extend to the first side in the axial direction of the stator core 21 from both ends of the V-phase busbar body portion 153v, and are connected to the winding-start coil end 34 of the V-phase coil 126v and the winding-end coil end 35 of the U-phase coil 126u.

The two W-phase busbar connection portions 154w extend to the first side in the axial direction of the stator core 21 from both ends of the W-phase busbar body portion 153w, and are connected to the winding-start coil end 34 of the W-phase coil 126w and the winding-end coil end 35 of the V-phase coil 126v.

As described above, the V-phase external terminal connection portion 155v of the V-phase busbar 151v and the W-phase external terminal connection portion 155w of the W-phase busbar 151w extend from the ends of the V-phase busbar body portion 153v and the W-phase busbar body portion 153w, respectively, as in the first embodiment. On the other hand, the U-phase external terminal connection portion 155u of the U-phase busbar 151u extends from a position other than both ends of the U-phase busbar body portion 153u. That is, in the present embodiment, the busbars 151 include a first busbar in which an external terminal connection portion extends outward in the radial direction from a position other than both ends of a busbar body portion, and a second busbar in which an external terminal connection portion extends outward in the radial direction from an end of a busbar body portion. Specifically, the busbars 151 include the U-phase busbar 151u which corresponds to the first busbar, and the V-phase busbar 151v and the W-phase busbar 151w which correspond to the second busbar.

The U-phase busbar 151u, the V-phase busbar 151v, and the W-phase busbar 151w are positioned on the outer peripheral side of the coil end portion 40 in the radial direction in a state of partially overlapping with each other in the radial direction or the axial direction.

FIG. 10 illustrates an example of the arrangement of the U-phase busbar 151u, the V-phase busbar 151v, and the W-phase busbar 151w with respect to the coil end portion 40.

As illustrated in FIG. 10, the U-phase external terminal connection portion 155u, the V-phase external terminal connection portion 155v, and the W-phase external terminal connection portion 155w partially overlap each other in the thickness direction.

The W-phase busbar body portion 153w of the W-phase busbar 151w which is the second busbar is located on the first side in the circumferential direction with respect to the U-phase external terminal connection portion 155u of the U-phase busbar 151u which is the first busbar. The V-phase busbar body portion 153v of the V-phase busbar 151v which is the second busbar is located on the second side in the circumferential direction with respect to the U-phase external terminal connection portion 155u of the U-phase busbar 151u which is the first busbar. The V-phase external terminal connection portion 155v and the W-phase external terminal connection portion 155w are arranged in the circumferential direction across the U-phase external terminal connection portion 155u.

A part of the U-phase busbar body portion 153u of the U-phase busbar 151u overlaps the W-phase busbar body portion 153w of the W-phase busbar 151w and the V-phase busbar body portion 153v of the V-phase busbar 151v when viewed in the axial direction.

As described above, at least two of the U-phase busbar 151u, the V-phase busbar 151v, and the W-phase busbar 151w are positioned to partially overlap each other when viewed in the axial direction. Therefore, the number of busbars arranged in the radial direction can be reduced, whereby the stator 102 that is compact in the radial direction can be obtained.

As described above, in the stator 102 according to the present embodiment, the plurality of busbars 151 includes one first busbar in which an external terminal connection portion 155 extends outward in the radial direction from a position other than both ends of the busbar body portion 153, and two second busbars in which the external terminal connection portions 155 extend outward in the radial direction from the ends of the busbar body portions 153. The busbar body portion 153 of one of the two second busbars 151 is located on the first side in the circumferential direction with respect to the external terminal connection portion 155 of the first busbar. The busbar body portion 153 of the other busbar 151 of the two second busbars is located on the second side in the circumferential direction with respect to the external terminal connection portion 155 of the first busbar. The external terminal connection portions 155 of the two second busbars are arranged in the circumferential direction across the external terminal connection portion 155 of the first busbar.

As described above, the busbar body portions 153 of the two second busbars are located at different positions in the circumferential direction of the stator core 21. Therefore, the busbar body portions 153 of the two second busbars do not overlap each other in the radial direction and the axial direction. Therefore, the number of busbars positioned to overlap each other in the radial direction or the axial direction of the stator core can be reduced as compared with a configuration in which three busbars are positioned to overlap each other in the radial direction or the axial direction. Therefore, the stator 102 that is compact in the radial direction or in the axial direction is obtained.

Note that the U-phase busbar 151u, the V-phase busbar 151v, and the W-phase busbar 151w may overlap each other in an arrangement other than the abovementioned arrangement. The U-phase busbar 151u, the V-phase busbar 151v, and the W-phase busbar 151w may overlap each other when viewed in the radial direction.

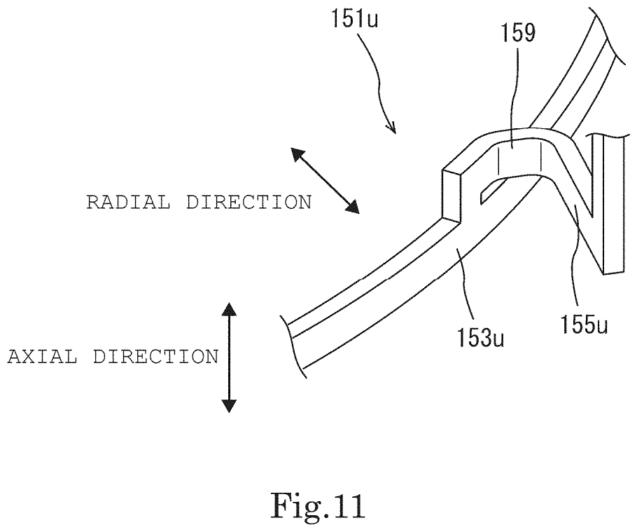

Next, a connection structure between the U-phase busbar body portion 153u and the U-phase external terminal connection portion 155u will be described. FIG. 11 is a partially enlarged view of a connection portion between the U-phase busbar body portion 153u and the U-phase external terminal connection portion 155u when viewed in a direction different from that in FIG. 10.

As illustrated in FIG. 11, the U-phase external terminal connection portion 155u has a U-shaped curved portion 159 at a connection portion with the U-phase busbar body portion 153u when viewed in the axial direction. An end of the curved portion 159 on the U-phase busbar body portion 153u side overlaps the U-phase busbar body portion 153u in the axial direction of the stator core 21. The U-phase external terminal connection portion 155u extends outward in the radial direction from the U-phase busbar body portion 153u while curving at the curved portion 159, when viewed in the axial direction.

As described above, the connection portion between the U-phase external terminal connection portion 155u and the U-phase busbar body portion 153u of the U-phase busbar 151u, which is the first busbar, extends along the U-phase busbar body portion 153u. In the configuration in which the external terminal connection portion extends from a position other than both ends of the busbar body portion, when the external terminal connection portion extends in the axial direction from the busbar body portion, the external terminal connection portion protrudes in the axial direction. However, with the abovementioned configuration, the U-phase external terminal connection portion 155u does not protrude in the axial direction, whereby the stator 102 which is compact in the axial direction can be obtained.

In the present embodiment, the U-phase busbar 151u is the first busbar, but the V-phase busbar 151v or the W-phase busbar 151w may be the first busbar.

A connection method for connecting the U-phase coil 126u, the V-phase coil 126v, and the W-phase coil 126w in the present embodiment will be described.

In the present embodiment, the U-phase coil 126u, the V-phase coil 126v, and the W-phase coil 126w are Δ-connected by the U-phase busbar 151u, the V-phase busbar 151v, and the W-phase busbar 151w.

Specifically, the winding-start coil end 34 of the U-phase coil 126u is connected to the U-phase busbar connection portion 154u of the U-phase busbar 151u. The winding-start coil end 34 of the V-phase coil 126v is connected to the V-phase busbar connection portion 154v of the V-phase busbar 151v. The winding-start coil end 34 of the W-phase coil 126w is connected to the W-phase busbar connection portion 154w of the W-phase busbar 151w.

The winding-end coil end 35 of the U-phase coil 126u is connected to the V-phase busbar connection portion 154v of the V-phase busbar 151v. The winding-end coil end 35 of the V-phase coil 126v is connected to the W-phase busbar connection portion 154w of the W-phase busbar 151w. The winding-end coil end 35 of the W-phase coil 126w is connected to the U-phase busbar connection portion 154u of the U-phase busbar 151u.

As a result, the stator 102 can be obtained in which the U-phase coil 126u, the V-phase coil 126v, and the W-phase coil 126w wound around the stator core 21 are Δ-connected by the U-phase busbar 151u, the V-phase busbar 151v, and the W-phase busbar 151w.

That is, in the stator 102 according to the present embodiment, the winding-end coil end 35 of each of the multi-phase coils 126 is connected to the busbar connection portion 154 of the busbar 151 to which the winding-start coil end 34 of the coil 126 of another phase is connected. Thus, the stator 102 in which the multi-phase coils 126 wound around the stator core 21 are A-connected by the busbars 151 can be obtained.

In the stator of the present embodiment, it is possible to obtain a stator in which the coils are Y-connected by changing the positions of the busbar connection portions with respect to the coils 126.

For example, the busbars may further include a neutral point busbar, and the winding-end coil ends 35 of the U-phase coil 126u, the V-phase coil 126v, and the W-phase coil 126w may be connected to the neutral point busbar. With this configuration, a stator can be obtained in which the U-phase coil 126u, the V-phase coil 126v, and the W-phase coil 126w wound around the stator core 21 are Y-connected by the U-phase busbar, the V-phase busbar, the W-phase busbar, and the neutral point busbar.

While the embodiments of the present invention have been described above, the above embodiments are merely examples for implementing the present invention. Thus, the present invention is not limited to the embodiments described above, and the embodiments described above may be appropriately modified and implemented without departing from the scope of the present invention.

In the first and second embodiments, the coils 26, 126 include three-phase coils. However, the coils may include multi-phase coils other than three-phase coils.

In the first embodiment, the coils 26 include two sets of three-phase coils. However, the coils may include one set or three or more sets of three-phase coils.

In the second embodiment, the coils 126 include one set of three-phase coils. However, the coils may include two or more sets of three-phase coils.

In the first and second embodiments, all the second coil connection portions 33 are located on the first side in the axial direction with respect to the stator core 21, and all the first coil connection portions 31 are located on the second side in the axial direction with respect to the stator core 21. However, all the second coil connection portions may be located on the second side in the axial direction with respect to the stator core. All the first coil connection portions may be located on the first side in the axial direction with respect to the stator core. A part of the second coil connection portions may be located on the first side in the axial direction with respect to the stator core. A part of the first coil connection portions may be located on the second side in the axial direction with respect to the stator core. A part of the second coil connection portions may be located on the second side in the axial direction with respect to the stator core. A part of the first coil connection portions may be located on the first side in the axial direction with respect to the stator core.

In the first and second embodiments, the winding-start coil ends 34 and the winding-end coil ends 35 are located on the side where the second coil connection portions 33 are located in the axial direction with respect to the stator core 21. However, the winding-start coil ends may be located on either the first side or the second side in the axial direction with respect to the stator core. In addition, the winding-end coil ends may be located on either the first side or the second side in the axial direction with respect to the stator core.

In the first and second embodiments described above, all the winding-start coil ends 34 have coil ends that are portions protruding from the stator core 21, extend outward in the radial direction of the stator core 21, and have tips extending toward the first side in the axial direction of the stator core 21. However, at least a part of the winding-start coil ends or the winding-end coil ends may have the coil end.

In the second embodiment described above, the winding-end coil end 35 of the U-phase coil 126u is connected to the V-phase busbar connection portion 154v of the V-phase busbar 151v, the winding-end coil end 35 of the V-phase coil 126v is connected to the W-phase busbar connection portion 154w of the W-phase busbar 151w, and the winding-end coil end 35 of the W-phase coil 126w is connected to the U-phase busbar connection portion 154u of the U-phase busbar 151u. However, the winding-end coil end of the U-phase coil may be connected to the W-phase busbar connection portion of the W-phase busbar, the winding-end coil end of the V-phase coil 126v may be connected to the U-phase busbar connection portion of the U-phase busbar, and the winding-end coil end of the W-phase coil may be connected to the V-phase busbar connection portion of the V-phase busbar.

In the first and second embodiments, the stator core 21 has a cylindrical shape. However, the stator core may have a shape other than the cylindrical shape as long as the stator core is tubular.

In the first and second embodiments, the motor 1 is a so-called inner rotor type motor in which the rotor 3 is located so as to be rotatable about the central axis P in the tubular stator 2. However, the motor may be a so-called outer rotor type motor in which a stator is located in a tubular rotor.

The present invention can be used for a stator that electrically connects a coil having high rigidity and an external device using a busbar.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A stator comprising:
a stator core having a plurality of slots extending in an axial direction;
multi-phase coils partially accommodated in the plurality of slots;
a plurality of external terminals electrically connected to a power supply source; and
a plurality of busbars electrically connecting the plurality of external terminals and the multi-phase coils, respectively, wherein
each of the coils includes
a plurality of slot accommodation portions located in the plurality of slots,
a plurality of coil connection portions located on a first side and on a second side in the axial direction with respect to the stator core and connecting the slot accommodation portions,
a first coil end located at an end of the coil, extending from the slot accommodation portion, and protruding to the first side or the second side in the axial direction of the stator core, and
a second coil end located at an end of the coil, extending from the slot accommodation portion, and protruding to the first side or the second side in the axial direction of the stator core,
each of the busbars includes
a busbar body portion positioned to overlap at least one of the first coil end and the second coil end when viewed in a radial direction of the stator core, the busbar body portion extending in a circumferential direction of the stator core,
a busbar connection portion extending from the busbar body portion toward the first side in the axial direction, and
an external terminal connection portion extending outward in the radial direction from the busbar body portion and connected to the external terminal,
the first coil end and the second coil end of each of the multi-phase coils extend from a radially outermost side of the slots toward the first side or the second side in the axial direction, and
either the first coil ends or the second coil ends of the multi-phase coils are connected to the busbar connection portions of different busbars among the plurality of busbars.

2. The stator according to claim 1, wherein
the multi-phase coils include three-phase coils,
the plurality of busbars includes three busbars,
the plurality of external terminals includes three external terminals, and
each of the three busbars electrically connects one of the three external terminals and a coil of one phase from among the three-phase coils.

3. The stator according to claim 2, wherein
at least two of the plurality of busbars are positioned to partially overlap each other when viewed in the axial direction of the stator core.

4. The stator according to claim 1, further comprising
a neutral point busbar positioned to overlap the first coil ends and the second coil ends when viewed in the radial direction of the stator core, wherein
the other of the first coil ends and the second coil ends of the multi-phase coils are connected to the neutral point busbar.

5. The stator according to claim 1, wherein
the other of the first coil end and the second coil end of each of the multi-phase coils is connected to the busbar connection portion of the busbar to which one of the first coil end and the second coil end of a coil of another phase is connected.

6. The stator according to claim 1, wherein
the plurality of busbars includes:
a first busbar in which the external terminal connection portion extends outward in the radial direction from a position other than both ends of the busbar body portion; and
a second busbar in which the external terminal connection portion extends outward in the radial direction from an end of the busbar body portion, and
the external terminal connection portion of the first busbar has a curved portion that has a U shape when viewed in the axial direction at a connection portion with the busbar body portion.

7. The stator according to claim 6, wherein
the plurality of busbars includes:
one first busbar that is the first busbar; and
two second busbars each of which is the second busbar,
the busbar body portion of one of the two second busbars is located on a first side in a circumferential direction with respect to the external terminal connection portion of the first busbar,
the busbar body portion of the other of the two second busbars is located on a second side in the circumferential direction with respect to the external terminal connection portion of the first busbar, and
the external terminal connection portions of the two second busbars are arranged in the circumferential direction across the external terminal connection portion of the first busbar.

8. The stator according to claim 1, wherein
the coils are formed from a rectangular wire.

9. A motor comprising the stator according to claim 1.
